(19) United States
(12) Patent Application Publication
(10) Pub. No.: US 2026/0057814 A1
(43) Pub. Date: Feb. 26, 2026

(54) ELECTRONIC DEVICE AND INSPECTION DEVICE FOR INSPECTING THE SAME

(71) Applicant: Samsung Display Co., LTD., Yongin-si (KR)

(72) Inventor: SI-BEAK PYO, Yongin-si (KR)

(21) Appl. No.: 19/190,082

(22) Filed: Apr. 25, 2025

(30) Foreign Application Priority Data
Aug. 23, 2024 (KR) 10-2024-0113784

(51) Int. Cl. G09G 3/20; G06T 7/00; G09G 3/00

(52) U.S. Cl. CPC G09G 3/2007; G06T 7/0002; G09G 3/006; G06T 2207/20021; G09G 2320/0276; G09G 2320/0673; G09G 2340/0407

(57) ABSTRACT

An inspection device includes a driving voltage determination unit that determines a voltage level of a driving voltage based on a luminance signal corresponding to an image displayed on an electronic device, a driving voltage offset lookup table that stores an offset voltage for the driving voltage, a gamma voltage determination unit that adjusts the voltage level of the driving voltage based on the offset voltage and determines gamma voltages based on the luminance signal and an adjusted driving voltage adjusted from the driving voltage to generate a gamma lookup table, an offset compensation lookup table that stores an offset compensation value, and an offset compensation unit that outputs a final gamma lookup table which compensates for an error of the gamma lookup table based on the offset compensation value.

This application claims priority to Korean Patent Application No. 10-2024-0113784, filed on Aug. 23, 2024, and all the benefits accruing therefrom under 35 U.S.C. § 119, the content of which in its entirety is herein incorporated by reference.

### BACKGROUND

### 1. Field

Embodiments of the disclosure described herein relate to an electronic device and an inspection device for inspecting the same.

### 2. Description of the Related Art

Multimedia electronic devices such as a television (“TV”), a mobile phone, a tablet, a personal computer (“PC”), a navigation system, a game console, or the like may display images to users.

With the recent technological advancements in electronic devices, various forms of electronic devices are being developed. Additionally, display devices with a larger display area (or active area) and a smaller non-display area (or bezel area) are being developed to enhance user convenience and product aesthetics.

An electronic device may include electronic modules that receive external signals or provide output signals to external devices. These electronic modules, along with a display panel, are housed in an external case to form the display device.

### SUMMARY

Embodiments of the disclosure provide an electronic device capable of improving the display quality of a peripheral area next (adjacent) to an electronic module, and an inspection device for inspecting the electronic device.

In an embodiment of the disclosure, an inspection device includes a driving voltage determination unit that determines a voltage level of a driving voltage based on a luminance signal corresponding to an image displayed on an electronic device, a driving voltage offset lookup table that stores an offset voltage for the driving voltage, a gamma voltage determination unit that adjusts the voltage level of the driving voltage based on the offset voltage and determines gamma voltages based on the luminance signal and an adjusted driving voltage adjusted from the driving voltage to generate a gamma lookup table, an offset compensation lookup table that stores an offset compensation value, and an offset compensation unit that outputs a final gamma lookup table which compensates for an error of the gamma lookup table based on the offset compensation value.

In an embodiment, the gamma voltage determination unit may divide a display panel of the electronic device into a plurality of blocks, adjust the voltage level of the driving voltage based on the offset voltage in response to a state in which the luminance signal corresponding to a first block of the plurality of blocks is received, and generate the gamma lookup table based on the luminance signal and the adjusted driving voltage.

In an embodiment, the gamma voltage determination unit may generate the gamma lookup table based on the luminance signal and the driving voltage in response to a state in which the luminance signal corresponding to a second block of the plurality of blocks is received.

In an embodiment, the offset compensation unit may output the final gamma lookup table which compensates for the error of the gamma lookup table based on the offset compensation value in response to a state in which the luminance signal corresponding to the first block is received.

In an embodiment, the offset compensation unit may output the gamma lookup table as a compensated final gamma lookup table compensated from the final gamma lookup table in response to a state in which the luminance signal corresponding to the second block is received.

In an embodiment, the electronic device may include an electronic module, and the first block of the display panel may overlap the electronic module.

In an embodiment, the first block of the display panel may include a module area that overlaps the electronic module, a peripheral area that surrounds the module area, and a general area that surround the peripheral area.

In an embodiment, the display panel may include first pixels disposed in the general area and second pixels disposed in the peripheral area, and a pixel density of the second pixels may be greater than a pixel density of the first pixels.

In an embodiment, a luminance of the second pixels is higher than a luminance of the first pixels for a same grayscale level.

In an embodiment, the inspection device may further include a target luminance setting unit that outputs one of a plurality of normal target luminances corresponding to the second block and a plurality of extra target luminances corresponding to the first block as a current target luminance.

In an embodiment, the driving voltage determination unit may determine the voltage level of the driving voltage according to the current target luminance based on the luminance signal.

In an embodiment, the driving voltage offset lookup table may store a plurality of offset voltages, respectively corresponding to the plurality of extra target luminances.

In an embodiment, the target luminance setting unit may output one of the plurality of extra target luminances as the current target luminance in response to a state in which the luminance signal corresponding to the first block is received.

In an embodiment, the gamma voltage determination unit may adjust the voltage level of the driving voltage based on an offset voltage corresponding to the current target luminance among the plurality of offset voltages in response to a state in which the luminance signal corresponding to the first block is received.

In an embodiment, the offset compensation unit may store a plurality of offset compensation values respectively corresponding to the plurality of extra target luminances.

In an embodiment, the offset compensation unit may output the final gamma lookup table that compensates for the error of the gamma lookup table based on an offset compensation value corresponding to the current target luminance among the plurality of offset compensation values in response to a state in which the luminance signal corresponding to the first block is received.

In an embodiment of the disclosure, an electronic device includes an electronic module, a display panel including a plurality of pixels, a plurality of data lines, and a plurality of scan lines, a data driving circuit that drives the plurality of data lines, a scan driving circuit that drives the plurality of scan lines, a driving controller that receives a control signal and an input image signal and provides a data signal to the data driving circuit, a memory that stores a final gamma lookup table and a driving voltage signal, the final gamma lookup table being provided from an inspection device, and a voltage generator that generates a driving voltage corresponding to the driving voltage signal. The driving controller outputs the data signal corresponding to the input image signal by referring to the final gamma lookup table, the display panel includes a module area overlapping the electronic module, a peripheral area surrounding the module area, and a general area surrounding the peripheral area, and for the data signal with a same grayscale, a luminance of first pixels disposed in the general area among the plurality of pixels and a luminance of second pixels disposed in the peripheral area are different from each other.

In an embodiment, a pixel density of the second pixels disposed in the peripheral area of the display panel may be lower than a pixel density of the first pixels disposed in the general area.

In an embodiment, a bit width of the data signal corresponding to the second pixels is larger than a bit width of the data signal corresponding to the first pixels.

In an embodiment, for the data signal with the same grayscale, the luminance of the second pixels is higher than the luminance of the first pixels.

### BRIEF DESCRIPTION OF THE DRAWINGS

The above and other embodiments, advantages and features of the disclosure will become apparent by describing in detail embodiments thereof with reference to the accompanying drawings.

FIG. 1 is a perspective view of an embodiment of an electronic device according to the disclosure.

FIG. 2 is an exploded perspective view of the electronic device shown in FIG. 1.

FIG. 3 is a plan view illustratively showing a portion of a display panel.

FIG. 4 is a diagram illustratively showing an inspection system for inspecting an electronic device.

FIG. 5 shows an embodiment of dividing an electronic device into a plurality of blocks.

FIG. 6 is a block diagram illustratively showing a configuration of an inspection device.

FIG. 7 is a diagram illustratively showing a target luminance, a driving voltage signal, a driving voltage offset, and an offset compensation value of an inspection device.

FIG. 8 is a block diagram of an embodiment of an electronic device according to the disclosure.

### DETAILED DESCRIPTION

In the specification, the expression that a first component (or region, layer, part, etc.) is “on”, “connected with”, or “coupled with” a second component means that the first component is directly on, connected with, or coupled with the second component or means that a third component is interposed therebetween.

Like reference numerals denote like elements. Also, in drawings, the thickness, ratio, and dimension of components are exaggerated for effectiveness of description of technical contents. The term “and/or” includes one or more combinations of the associated listed items.

The terms “first”, “second”, etc. are used to describe various components, but the components are not limited by the terms. The terms are used only to differentiate one component from another component. For example, without departing the scope of the disclosure, a first component may be referred to as a second component, and similarly, a second component may be referred to as a first component. The articles “a”, “an”, and “the” are singular in that they have a single referent, but the use of the singular form in the specification should not preclude the presence of more than one referent.

Also, the terms “under”, “beneath”, “on”, “above”, etc. are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

The terms such as “unit,” “device” and “controller” as used herein are intended to mean a hardware component such as a circuitry that performs a predetermined function. The hardware component may include a field-programmable gate array (“FPGA”) or an application-specific integrated circuit (“ASIC”), for example.

Unless otherwise defined, all terms (including technical terms and scientific terms) used in this specification have the same meaning as commonly understood by those skilled in the art to which the disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the disclosure will be described with reference to accompanying drawings.

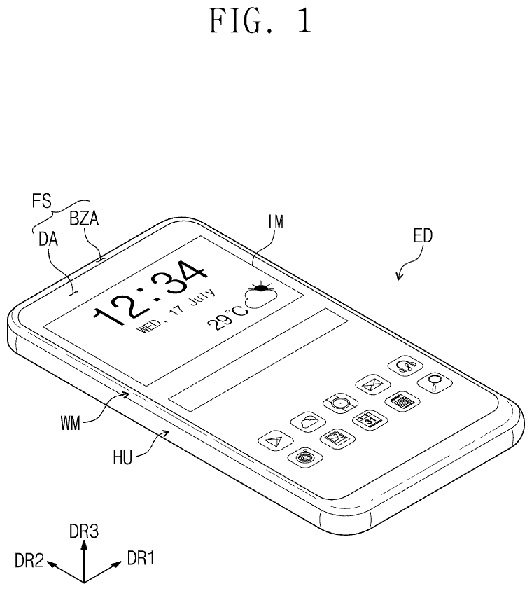

FIG. 1 is a perspective view of an embodiment of an electronic device ED according to the disclosure.

The electronic device ED may include various embodiments. In an embodiment, the electronic device ED may include a tablet personal computer (“PC”), a notebook computer, a computer, a smart television, or the like. In the illustrated embodiment, the electronic device ED is illustrated as a smart phone, for example.

As illustrated in FIG. 1, the electronic device ED may display an image IM on a front surface FS thereof. The front surface may be defined as a surface parallel to a surface defined by a first direction DR1 and a second direction DR2. The front surface FS may include a display area DA and a bezel area BZA next (adjacent) to the display area DA.

The electronic device ED may display the image IM on the display area DA. In FIG. 1, a clock and icons are illustrated in an embodiment of the image IM.

The display area DA may have a quadrangular shape, e.g., rectangular shape parallel to each of first direction DR1 and a second direction DR2. However, this is illustrated as an example. The display area DA may have various shapes, not limited to a particular embodiment.

The bezel area BZA is next (adjacent) to the display area DA. The bezel area BZA may surround the display area DA. However, this is illustrated as an example. In an embodiment, the bezel area BZA may be disposed next (adjacent) to only one side of the display area DA or may be omitted. The electronic device ED in an embodiment of the disclosure may be implemented with various embodiments, and is not limited to an embodiment.

The normal direction of the front surface FS may correspond to a thickness direction DR3 (hereinafter referred to as a third direction) of the electronic device ED. In the illustrated embodiment, a front surface (or an upper/top surface) and a back surface (or a lower/bottom surface) of each member are defined with respect to a direction in which the image IM is displayed. The front surface and the back surface are opposite each other in the third direction DR3.

Directions that the first, second, and third directions DR1, DR2, and DR3 indicate may be relative in concept and may be changed to different directions. Hereinafter, the first to third directions refer to the same reference numerals as the directions indicated by the first to third directions DR1, DR2, and DR3, respectively.

The electronic device ED may include a window WM and an outer case HU. The window WM may be coupled to the outer case HU to define an outer appearance of the electronic device ED.

The window WM may include glass or plastic. The window WM may have a multi-layer structure or a single-layer structure. In an embodiment, the window WM may have a stacked structure of a plurality of plastic films bonded by an adhesive or may have a stacked structure of a glass substrate and a plastic film bonded by an adhesive, for example. The front surface FS of the electronic device ED may be substantially defined by the front surface FS of the window.

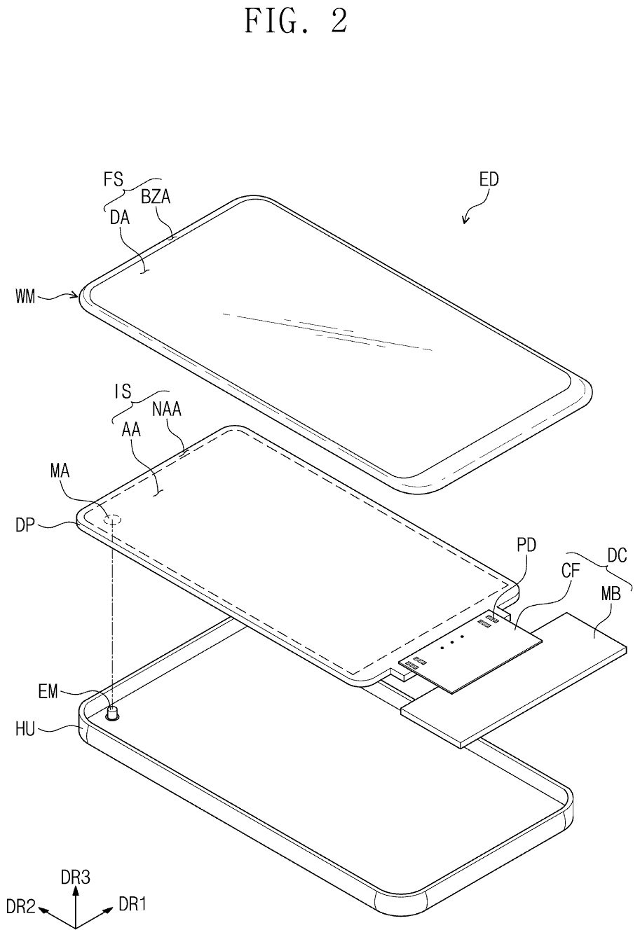

FIG. 2 is an exploded perspective view of the electronic device ED shown in FIG. 1.

Referring to FIGS. 1 and 2, the electronic device ED may include the window WM, a display panel DP, a circuit board DC, an electronic module EM, and the outer case HU. The window WM may be coupled to the outer case HU to define an outer appearance of the electronic device ED.

The window WM is placed on the display panel DP to cover a front surface IS of the display panel DP. The window WM may include an optically transparent material. In an embodiment, the window WM may include glass or plastic. The window WM may include a multi-layer or single-layer structure, for example. In an embodiment, the window WM may have a stacked structure of a plurality of plastic films bonded by an adhesive or may have a stacked structure of a glass substrate and a plastic film bonded by an adhesive, for example.

The window WM includes the front surface FS that is exposed to the outside. The front surface FS of the electronic device ED may be substantially defined by the front surface FS of the window.

The display area DA of the window WM may be an optically transparent area. The display area DA may have a shape corresponding to an active area AA of the display panel DP. In an embodiment, the display area DA may overlap the front surface or at least portion of the active area AA, for example. The image IM displayed in the active area AA of the display panel DP may be externally visible through the display area DA.

The bezel area BZA may be an area with relatively low light transmittance compared to the display area DA. The bezel area BZA may define the shape of the display area DA. The bezel area BZA may be next (adjacent) to the display area DA and may surround the display area DA.

The bezel area BZA may have a given color. W hen the window WM is provided as a glass or plastic substrate, the bezel area BZA may be a printed or deposited color layer on one side of the glass or plastic substrate. In an alternative embodiment, the bezel area BZA may be formed by tinting a corresponding area of the glass or plastic substrate.

The bezel area BZA may cover a non-active area NAA of the display panel DP to block the non-active area NAA from being visible from the outside. However, this is shown as one of embodiments, and in some embodiments, the window WM may not include the bezel area BZA.

The display panel DP may display the image IM and detect a user input. The display panel DP may include the front surface IS including the active area AA and the non-active area NAA. The active area AA may be activated depending on an electrical signal.

The non-active area NAA may be an area covered by the bezel area BZA. The non-active area NAA may be next (adjacent) to the active area AA. The non-active area NAA may surround the active area AA. A driving circuit or driving wires for driving the active area AA may be disposed in the non-active area NAA.

The non-active area NAA may include various signal lines, pads PD, or electronic devices that provide electrical signals to the active area AA. The non-active area NAA may be covered by the bezel area BZA and may not be visible from the outside.

In the illustrated embodiment, the display panel DP is assembled in a flat state with the active area AA and the non-active area NAA facing the window WM. However, this is shown for an example, and a portion of the non-active area NAA of the display panel DP may be curved. In this case, a portion of the non-active area NAA may face the back surface of the electronic device ED, thereby reducing the bezel area BZA in the front surface of the electronic device ED. In an alternative embodiment, the display panel DP may be assembled with a portion of the active area AA curved. In an alternative embodiment, the non-active area NAA may be omitted in the display panel DP in an embodiment of the disclosure.

The display panel DP and the window WM may be bonded together by a transparent adhesive, such as a pressure sensitive adhesive film (“PSA”), an optically clear adhesive film (“OCA”), or an optically clear resin (“OCR”).

Further, an anti-reflector may be further disposed between the display panel DP and the window WM. The anti-reflector may reduce the reflectivity of external light incident from the upper side of the window WM. In an embodiment, the anti-reflector may include a retarder and a polarizer.

In the active area AA of the display panel DP, a module area MA may be defined. The module area MA may be an area overlapping the electronic module EM to be described later. The display panel DP may receive an external signal desired by the electronic module EM via the module area MA, or may provide a signal output from the electronic module EM to the outside. In an embodiment of the disclosure, the module area MA may be disposed in the active area AA instead of the non-active area NAA, thereby reducing the area of the non-active area NAA and the bezel area BZA.

The shape of the module area MA may be defined in various ways. In the illustrated embodiment, the module area MA is shown as having a circular shape for ease of description, but is not limited thereto. The module area MA may have a variety of shapes, such as an elliptical shape, a polygonal shape, and a shape including curved sides and straight sides, and is not limited to a particular embodiment.

At least a portion of the module area MA of the display panel DP may be surrounded by the active area AA. In the illustrated embodiment, the module area MA may be spaced apart from the non-active area NAA. The module area MA is illustrated as being defined within the active area AA such that the module area MA is surrounded on all edges by the active area AA. In the coupled state of the electronic device ED in the illustrated embodiment, the display area DA of the window WM may overlap the module area MA of the display panel DP.

The circuit board DC may be connected to the display panel DP. The circuit board DC may include a flexible board CF and a main board MB. The flexible board CF may include an insulating film and conductive wires disposed (e.g., mounted) on the insulating film. The conductive wires may be connected to the pads PD to electrically connect the circuit board DC and the display panel DP.

In the illustrated embodiment, the flexible board CF may be assembled in a bent state. Accordingly, the main board MB may be disposed on the back surface of the display panel DP and may be reliably accommodated within a space provided by the outer case HU. In an alternative embodiment, in the illustrated embodiment, the flexible board CF may be omitted, and in this case, the main board MB may be directly connected to the display panel DP.

The main board MB may include signal lines and electronic elements which are not shown. The electronic elements may be connected to the signal lines and electrically connected to the display panel DP. The electronic elements may generate various electrical signals, such as signals for generating the image IM, signals for detecting the user input, or process the detected signals. A plurality of main boards MB may be also provided respectively corresponding to a plurality of electrical signals for generating and processing, and the disclosure is not limited to a particular embodiment. Although not shown, the electronic module EM may be electrically connected to the main board MB.

Furthermore, in the electronic device ED in an embodiment of the disclosure, a driving circuit for providing electrical signals to the active area AA may be directly disposed (e.g., mounted) on the display panel DP. The driving circuit may be disposed (e.g., mounted) as a chip, or may be formed together with the pixels (to be described later). In this case, the area of the circuit board DC may be reduced or omitted. The electronic device ED in an embodiment of the disclosure may include various embodiments and is not limited to a particular embodiment.

The electronic module EM may be disposed under the window WM. The electronic module EM may overlap the module area MA in the plane. The electronic module EM may receive external inputs transferred through the module area MA or may provide outputs through the module area MA. According to the disclosure, the electronic module EM may be disposed to overlap the active area AA to prevent an increase in the non-active area NA A and the bezel area BZA. In an embodiment, the electronic module EM may be a camera.

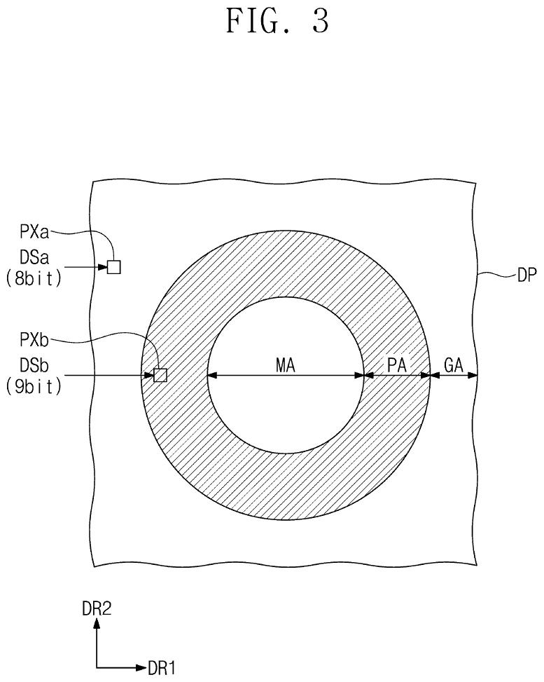

FIG. 3 is a plan view illustratively showing a portion of the display panel DP.

Referring to FIG. 3, the active area AA (refer to FIG. 2) of the display panel DP may be divided into the module area MA, a peripheral area PA, and a general area GA. At least a portion of the module area MA may be surrounded by the peripheral area PA. In the example illustrated in FIG. 3, the module area MA may be surrounded by the peripheral area PA on all edges.

The module area MA may overlap the electronic module EM (refer to FIG. 2). Although the module area MA is illustrated as being circular in FIG. 3, the disclosure is not limited thereto. The module area MA may have various shapes, such as an oval, a square, a rhombus, or the like.

The peripheral area PA may be next (adjacent) to the module area MA and may have a shape that surrounds the module area MA. A s illustrated in FIG. 3, when the module area MA is circular, the peripheral area PA may have a closed curve shape (donut or circular ring shape) that is continuously connected along the edges of the module area MA. The peripheral area PA may be designed in various ways according to the shape of the module area MA.

The general area GA may correspond to an area in the active area AA (refer to FIG. 2) excluding the module area MA and the peripheral area PA. The general area GA may surround the peripheral area PA.

It is preferable that the module area MA of the display panel DP has a light transmittance that allows external light to be sufficiently provided to the electronic module EM. That is, the module area MA has a higher light transmittance than the peripheral area PA. In an embodiment, the pixel density of second pixels PXb disposed in the module area MA may be less than 50% of the pixel density of first pixels PXa disposed in the general area GA, for example.

To prevent the luminance deviation due to a difference in pixel density between the module area MA and the general area GA from being perceived by a user, the pixel density of the second pixels PXb disposed in the peripheral area PA of the display panel DP may be higher than the pixel density of the pixels disposed in the module area MA and lower than the pixel density of the first pixels PXa disposed in the general area GA.

A luminance difference due to the difference between the pixel density of the first pixels PXa disposed in the general area GA and the pixel density of the second pixels PXb disposed in the peripheral area PA may be perceived by the user. Therefore, it is desired to make the luminance of the second pixels PXb disposed in the peripheral area PA higher than the luminance of the first pixels PXa disposed in the general area GA for the same grayscale level. To increase the luminance of the second pixels PXb disposed in the peripheral area PA while maintaining a grayscale resolution, it is desired to make the bit width of a second data signal DSb provided to the second pixels PXb larger than the bit width of a first data signal DSa provided to the first pixels PXa. In an embodiment, when the bit width of the first data signal DSa provided to the first pixels PXa is 8 bits, the bit width of the second data signal DSb provided to the second pixels PXb may be 9 bits, for example.

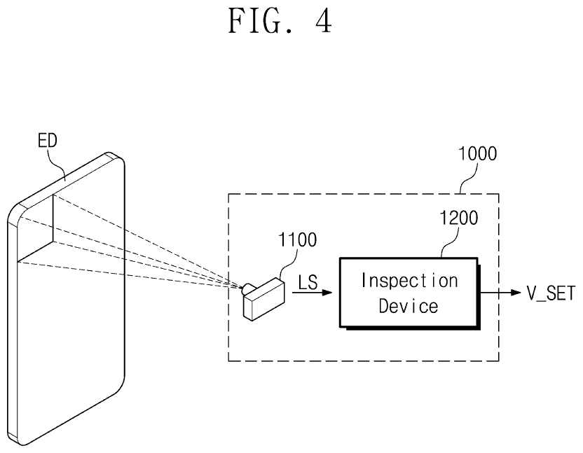

FIG. 4 is a diagram illustratively showing an inspection system 1000 for inspecting the electronic device ED.

Referring to FIG. 4, the inspection system 1000 may include a camera (or an imaging device) 1100 and an inspection device 1200. Although the electronic device ED to be inspected by the inspection system 1000 is illustrated as being a mobile phone in FIG. 4, the disclosure is not limited thereto. The electronic device ED may include large-sized electronic devices such as televisions or outdoor billboards, as well as relatively small and medium-sized electronic devices such as personal computers, notebook computers, kiosks, car navigation units, cameras, tablet PCs, smart phones, Personal Digital Assistants (“PDAs”), Portable Multimedia Players (“PMPs”), game consoles, or wristwatch-type electronic devices.

As illustrated in FIG. 4, the camera 1100 may capture an image displayed on the electronic device ED and provide a luminance signal (or a detection image signal) LS corresponding to the image to the inspection device 1200. The inspection device 1200 may determine the characteristics of the electronic device ED based on the luminance signal LS provided from the camera 1100. The inspection device 1200 may output a voltage setting signal V_SET for setting the voltage levels of voltages used in the electronic device ED based on the determined characteristics.

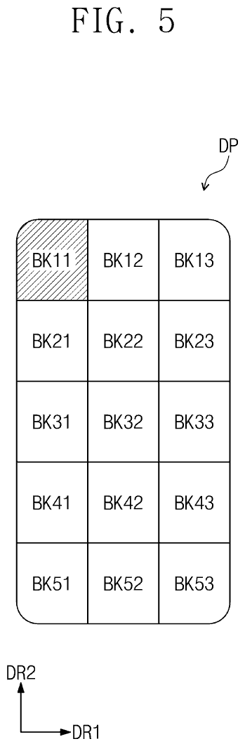

FIG. 5 shows an embodiment of dividing the electronic device ED into a plurality of blocks.

Referring to FIGS. 4 and 5, the inspection system 1000 may divide the electronic device ED into a plurality of areas. In an embodiment, the inspection system 1000 may divide the display panel DP of the electronic device ED into three blocks in the first direction DR1 and five blocks in the second direction DR2, that is, fifteen blocks BK11, BK12, BK13, BK21, BK22, BK23, BK31, BK32, BK33, BK41, BK42, BK43, BK51, BK52, and BK53, for example.

Although the display panel DP is illustrated as being divided into fifteen blocks BK11-BK53 in FIG. 5, the disclosure is not limited thereto. The criteria for dividing the display panel DP into a plurality of blocks may be determined according to the imaging area of the camera 1100. In another embodiment, a number of blocks may be greater than fifteen with a relatively larger imaging area, and a number of blocks may be less than fifteen with a relatively smaller imaging area, for example.

The inspection system 1000 may sequentially capture images of the blocks BK11-BK53 of the display panel DP and may determine the characteristics of each of the blocks BK11-BK53.

For convenience of description, among the fifteen blocks BK11-BK53, the block BK11 overlapping the peripheral area PA (refer to FIG. 3) is also referred to as a first block BK11, and the blocks BK12-BK53 overlapping the general area GA (refer to FIG. 3) are also referred to as second blocks BK12-BK53.

The first block BK11 may include the first pixels PXa and the second pixels PXb. The second blocks BK12-BK53 may include first pixels PXa. As described with reference to FIG. 3, the bit width of the second data signal DSb provided to the second pixels PXb disposed in the peripheral area PA may be larger than the bit width of the first data signal DSa provided to the first pixels PXa disposed in the general area GA, and the luminance of the second pixels PXb may be higher than the luminance of the first pixels PXa. Due to the difference in luminance, when the first block BK11 and the second blocks BK12-BK53 are inspected under the same conditions, the inspection accuracy may be lowered.

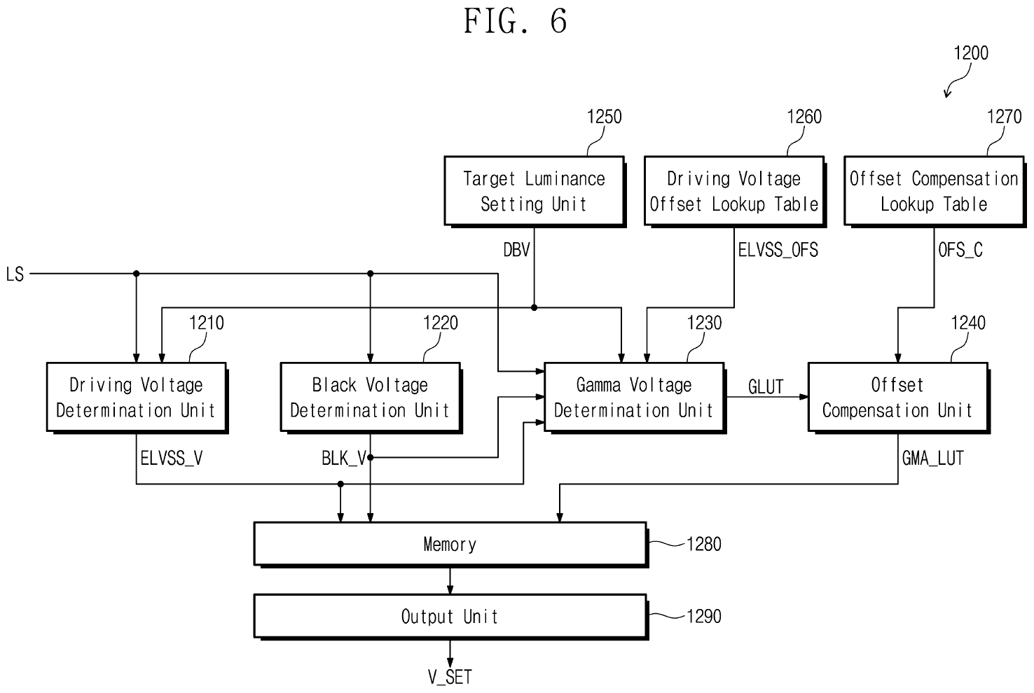

FIG. 6 is a block diagram illustratively showing a configuration of the inspection device 1200.

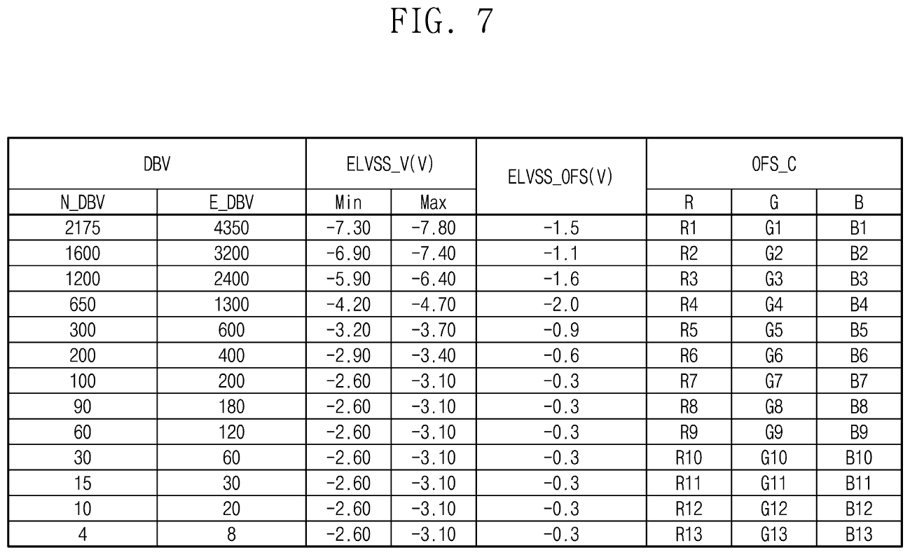

FIG. 7 is a diagram illustratively showing a target luminance DBV, a driving voltage signal ELVSS_V, a driving voltage offset ELVSS_OFS, and an offset compensation value OFS_C of the inspection device 1200.

Referring to FIG. 4, FIG. 6, and FIG. 7, the inspection device 1200 may include a driving voltage determination unit 1210, a black voltage determination unit 1220, a gamma voltage determination unit 1230, an offset compensation unit 1240, a target luminance setting unit 1250, a driving voltage offset lookup table 1260, an offset compensation lookup table 1270, a memory 1280, and an output unit 1290.

The driving voltage determination unit 1210 may determine a voltage level of a driving voltage based on the luminance signal LS provided from the camera 1100, and output the driving voltage signal ELVSS_V. In an embodiment, the driving voltage may be a voltage desired for the operation of pixels PXa and PXb (refer to FIG. 3). In an embodiment, the driving voltage signal ELVSS_V may include a maximum voltage M ax and a minimum voltage M in.

The driving voltage determination unit 1210 may determine the voltage level of the driving voltage based on the luminance signal LS according to the target luminance DBV provided from the target luminance setting unit 1250, and output the driving voltage signal ELVSS_V. The target luminance DBV provided from the target luminance setting unit 1250 may be a current target luminance.

In FIG. 7, a normal target luminance N_DBV may be a target luminance for the second blocks BK12-BK53, and an extra target luminance E_DBV may be a target luminance for the first block BK11. Since the luminance of the second pixels PXb disposed in the peripheral area PA is higher than the luminance of the first pixels PXa disposed in the general area GA, the target luminance for the first block BK11 may be higher than the target luminance for the second blocks BK12-BK53.

In an embodiment, the driving voltage determination unit 1210 may determine a voltage level of the driving voltage based on the luminance signal LS according to the normal target luminance N_DBV, and output the driving voltage signal ELVSS_V. The driving voltage signal ELVSS_V may be stored in the memory 1280.

The normal target luminance N_DBV and the extra target luminance E_DBV illustrated in FIG. 7 are merely illustrative embodiments, and the disclosure is not limited thereto.

The black voltage determination unit 1220 may determine a voltage level of the black voltage based on the luminance signal LS provided from the camera 1100, and output a black voltage signal BLK_V. In an embodiment, the black voltage may be the voltage level of the first data signals DSa (refer to FIG. 3) and the second data signals DSb (refer to FIG. 3) when an image with black grayscale is provided to the pixels PXa and PXb. The black voltage signal BLK_V may be stored in the memory 1280.

The gamma voltage determination unit 1230 may determine gamma voltages corresponding to a plurality of grayscales of the first data signals DSa and the second data signals DSb provided to the pixels PXa and PXb based on the luminance signal LS provided from the camera 1100, the driving voltage signal ELVSS_V, and the black voltage signal BLK_V. The gamma voltages respectively corresponding to the plurality of grayscales are written in a gamma lookup table GLUT and provided to the offset compensation unit 1240.

In an embodiment, when the luminance signal LS corresponds to the second blocks BK12-BK53, the target luminance DBV provided from the target luminance setting unit 1250 may be the normal target luminance N_DBV. The gamma voltage determination unit 1230 may generate the gamma lookup table GLUT for the plurality of grayscales of the first data signals DSa provided to the first pixels PXa of the second blocks BK12-BK53 according to the normal target luminance N_DBV provided from the target luminance setting unit 1250.

In an embodiment, when the luminance signal LS corresponds to the first block BK11, the target luminance DBV provided from the target luminance setting unit 1250 may be the extra target luminance E_DBV. The gamma voltage determination unit 1230 may generate the gamma lookup table GLUT for the plurality of grayscales of the first data signals DSa provided to the first pixels PXa of the first block BK11 and the second data signals DSb provided to the second pixels PXb according to the extra target luminance E_DBV provided from the target luminance setting unit 1250.

Since the extra target luminance E_DBV is higher than the normal target luminance N_DBV, the margin of the driving voltage may be insufficient when determining the gamma voltage for the first block BK11. That is, the luminance of an image displayed on the second pixels PXb of the first block BK11 may be higher than the luminance of an image displayed on the first pixels PXa of the second blocks BK12-BK53. In this case, the voltage level of a driving voltage may be unstable, or the luminance of the image displayed on the second pixels PXb may differ from the target luminance.

Therefore, the inspection device 1200 may provide an offset voltage to the driving voltage during inspection of the first block BK11 to increase the accuracy of the determination of a gamma voltage for the first block BK11.

During inspection of the first block BK11, that is, when the luminance signal LS corresponding to the first block BK11 is received, the gamma voltage determination unit 1230 may receive an offset voltage ELVSS_OFS from the driving voltage offset lookup table 1260 and adjust the voltage level of the driving voltage. In an embodiment, when the extra target luminance E_DBV is 4350, the maximum voltage Max of the driving voltage is changed to −9.3 volts (V) by subtracting the voltage (−1.5 V) of the offset voltage ELVSS_OFS from a maximum voltage MAX (−7.8V) of the driving voltage signal ELVSS_V (i.e., −7.8 V−1.5 V=−9.3 V), and the minimum voltage M in is changed to −8.8 V by subtracting the voltage (−1.5 V) of the offset voltage ELVSS_OFS from a minimum voltage Min (−7.3V) of the driving voltage signal ELVSS_V (i.e., −7.3 V−1.5 V=−8.8 V), for example.

The gamma voltage determination unit 1230 may determine gamma voltages respectively corresponding to a plurality of grayscales of the first data signals DSa and the second data signals DSb provided to the pixels PXa and PXb based on the luminance signal LS provided from the camera 1100, the driving voltage adjusted and the black voltage signal BLK_V, after the voltage level of the driving voltage during inspection for the first block BK11. The gamma voltages respectively corresponding to the plurality of grayscales are written in the gamma lookup table GLUT and provided to the offset compensation unit 1240. The gamma lookup table GLUT generated after inspection of the first block BK11 may include gamma voltages shifted by the offset voltage ELVSS_OFS.

The offset compensation lookup table 1270 may store the offset compensation value OFS_C for compensating the gamma voltages shifted by the offset voltage ELVSS_OFS.

Each of the first pixels PXa and the second pixels PXb may correspond to one of a first color “R”, a second color “G”, and a third color “B”. The offset compensation value OFS_C may include compensation values respectively corresponding to the first color “R”, the second color “G”, and the third color “B” according to the extra target luminance E_DBV.

In an embodiment, when the offset voltage ELVSS_OFS is-1.5V when the extra target luminance E_DBV is 4350, the compensation values respectively corresponding to the first color “R”, the second color “G”, and the third color “B” may be R1, G1, and B1, for example.

Although only one compensation value R1, G1, or B1 among the compensation values corresponding to the first color “R”, the second color “G”, and the third color “B” respectively are illustrated in FIG. 7, the actual compensation values corresponding to the first color “R”, the second color “G”, and the third color “B” respectively may be plural.

In an embodiment, when the grayscale levels that the second pixels PXb are able to express are 511 when the extra target luminance E_DBV is 4350, the number of the actual compensation values corresponding to the first color “R”, the second color “G”, and the third color “B” respectively may be 511. That is, there are 511 compensation values corresponding to the first color “R”, 511 compensation values corresponding to the second color “G”, and 511 compensation values corresponding to the third color “B”.

In addition, when there are 256 grayscale levels that the first pixels PXa are able to express, the number of actual compensation values corresponding to the first color “R”, the second color “G”, and the third color “B” may be 256. That is, there are 256 compensation values corresponding to the first color “R”, 256 compensation values corresponding to the second color “G”, and 256 compensation values corresponding to the third color “B”.

The offset compensation lookup table 1270 may include compensation values respectively corresponding to the first color “R”, the second color “G”, and the third color “B” according to the extra target luminance E_DBV.

The offset compensation unit 1240 may compensate the gamma voltages included in the gamma lookup table GLUT for the voltage shifted by the offset voltage ELVSS_OFS based on the offset compensation lookup table 1270.

The offset compensation unit 1240 may stores a final gamma lookup table GMA_LUT in the memory 1280.

The output unit 1290 may provide the voltage setting signal V_SET including the driving voltage signal ELVSS_V, the black voltage signal BLK_V, and the final gamma lookup table GMA_LUT to the electronic device ED (refer to FIG. 4).

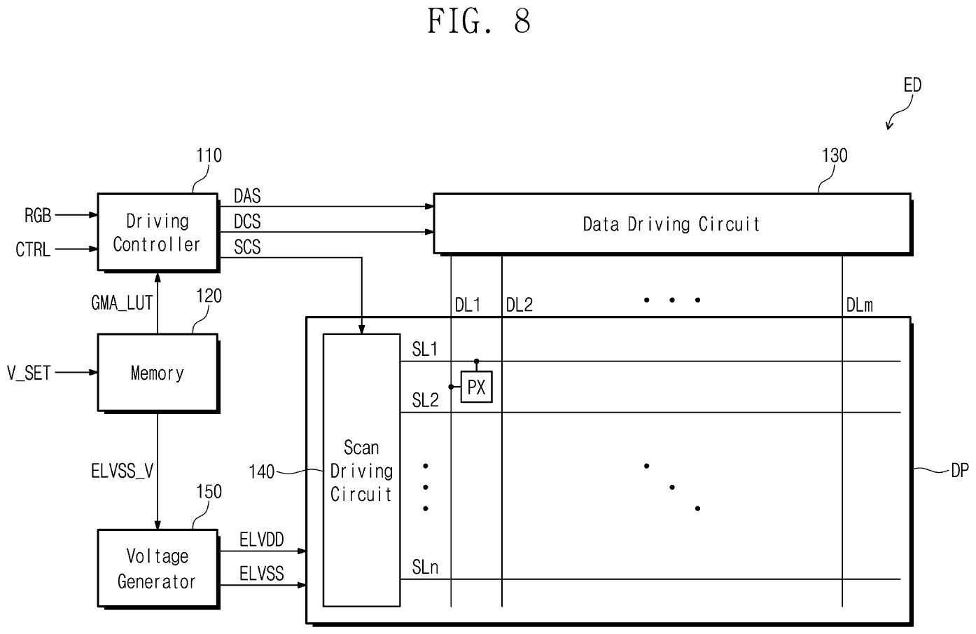

FIG. 8 is a block diagram of an embodiment of the electronic device ED according to the disclosure.

Referring to FIG. 8, the electronic device ED may include the display panel DP, a driving controller 110, a memory 120, a data driving circuit 130, a scan driving circuit 140, and a voltage generator 150.

The display panel DP may include a plurality of pixels PX, a plurality of data lines DL1-DLm, and a plurality of scan lines SL1-SLn. Here, m and n are natural numbers. Each of the plurality of pixels PX may be connected to a corresponding data line among the plurality of data lines DL1-DLm and may be connected to a corresponding scan line among the plurality of scan lines SL1-SLn.

The display panel DP is a panel that displays an image and may be one of various types of display panels, such as a liquid crystal display (“LCD”) panel, an electrophoretic display panel, an organic light-emitting diode (“OLED”) panel, a light-emitting diode (“LED”) panel, an electroluminescent (“EL”) panel, a field emission display (“FED”) panel, a surface-conduction electron-emitter display (“SED”) panel, a plasma display panel (“PDP”), and a cathode ray tube (“CRT”) panel.

The driving controller 110 may receive an input image signal RG B and a control signal CTRL from the outside. In an embodiment, the control signal CTRL may include at least one synchronization signal and at least one clock signal. The driving controller 110 may provide a data signal DA S obtained by processing the input image signal RGB according to the operating conditions of the display panel DP, to the data driving circuit 130. The driving controller 110 may provide a data control signal DCS to the data driving circuit 130 based on the control signal CTRL and provide a scan control signal SCS to the scan driving circuit 140. The data control signal DCS may include a horizontal synchronization start signal, a clock signal, and a line latch signal, and the scan control signal SCS may include a vertical synchronization start signal and an output enable signal.

The data driving circuit 130 may output grayscale voltages for driving the plurality of data lines DL1-DLm in response to the data control signal DCS and the data signal DAS from the driving controller 110. In an embodiment, the data driving circuit 130 may be implemented as an integrated circuit (“IC”). The data driving circuit 130 having an IC type may be directly disposed (e.g., mounted) in a predetermined area of the display panel DP or may be disposed (e.g., mounted) on a separate printed circuit board in a chip on film (“COF”) scheme, and then may be electrically connected to the display panel DP. In other embodiments, the data driving circuit 130 may be formed on the display panel DP using the same process as the driving circuit for the pixels PX.

The scan driving circuit 140 may drive the plurality of scan lines SL1-SLn in response to the scan control signal SCS from the driving controller 110. In an embodiment, the scan driving circuit 140 may be formed on the display panel DP using the same process as the pixels PX, but is not limited thereto. In an embodiment, the scan driving circuit 140 may be implemented as an integrated circuit (“IC”). The scan driving circuit 140 having an IC type may be directly disposed (e.g., mounted) in a predetermined area of the display panel DP or may be disposed (e.g., mounted) on a separate printed circuit board in a chip on film (“COF”) scheme, and then may be electrically connected to the display panel DP.

The memory 120 may store the voltage setting signal V_SET. The voltage setting signal V_SET stored in the memory 120 may be provided by the inspection device 1200 shown in FIG. 6. The voltage setting signal V_SET may include the driving voltage signal ELVSS_V and the final gamma lookup table GMA_LUT.

The driving controller 110 may provide the data signal DAS corresponding to an externally provided input image signal RGB to the data driving circuit 130 by referring to the final gamma lookup table GMA_LUT from the stored voltage setting signal V_SET stored in the memory 120. The data signal DAS may include the first data signal DSa and the second data signal DSb shown in FIG. 3.

The driving controller 110 may make the bit width of the second data signal DSb provided to the second pixels PXb disposed in the peripheral area PA (refer to FIG. 3) larger than the bit width of the first data signal DSa provided to the first pixels PXa disposed in the general area GA (refer to FIG. 3). Thus, the display quality of the peripheral area PA next (adjacent) to the electronic module EM (refer to FIG. 2) may be improved.

The voltage generator 150 may generate a first driving voltage ELVDD and a second driving voltage ELVSS. In an embodiment, a voltage level of the first driving voltage ELVDD and a voltage level of the second driving voltage ELVSS may be different from each other, and the voltage level of the second driving voltage ELVSS may be less than the first driving voltage ELVDD. The voltage generator 150 may determine the voltage level of the second driving voltage ELVSS in response to the driving voltage signal ELVSS_V.

Although described above with reference to the embodiments, it will be understood by those skilled in the art that various modifications and changes may be made in the disclosure without departing from the spirit and scope of the disclosure as set forth in the claims below. Furthermore, embodiments of the disclosure are not intended to limit the technical spirit of the disclosure. All technical spirits within the scope of the following claims and all equivalents thereof should be construed as being included within the scope of the disclosure.

The electronic device with the aforementioned configuration may provide data signals with relatively high grayscale resolution to the pixels in the peripheral area next (adjacent) to the electronic module. Therefore, the display quality in the peripheral area next (adjacent) to the electronic module may be improved.

Further, the issue of insufficient driving voltage margin may be resolved by temporarily changing the driving voltage during optical inspection of the area next (adjacent) to the electronic module.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. An inspection device comprising:
a driving voltage determination unit configured to determine a voltage level of a driving voltage based on a luminance signal corresponding to an image displayed on an electronic device;
a driving voltage offset lookup table configured to store an offset voltage for the driving voltage;
a gamma voltage determination unit configured to:
adjust the voltage level of the driving voltage based on the offset voltage;
determine gamma voltages based on the luminance signal and an adjusted driving voltage adjusted from the driving voltage; and
generate a gamma lookup table;
an offset compensation lookup table configured to store an offset compensation value; and
an offset compensation unit configured to output a final gamma lookup table which compensates for an error of the gamma lookup table based on the offset compensation value.

2. The inspection device of claim 1, wherein the gamma voltage determination unit is configured to:
divide a display panel of the electronic device into a plurality of blocks;
adjust the voltage level of the driving voltage based on the offset voltage in response to a state in which the luminance signal corresponding to a first block of the plurality of blocks is received; and
generate the gamma lookup table based on the luminance signal and the adjusted driving voltage.

3. The inspection device of claim 2, wherein the gamma voltage determination unit is configured to generate the gamma lookup table based on the luminance signal and the driving voltage in response to a state in which the luminance signal corresponding to a second block of the plurality of blocks is received.

4. The inspection device of claim 3, wherein the offset compensation unit is configured to output the final gamma lookup table which compensates for the error of the gamma lookup table based on the offset compensation value in response to the state in which the luminance signal corresponding to the first block is received.

5. The inspection device of claim 4, wherein the offset compensation unit is configured to output the gamma lookup table as the final gamma lookup table in response to the state in which the luminance signal corresponding to the second block is received.

6. The inspection device of claim 3, wherein the electronic device includes an electronic module, and wherein the first block of the display panel overlaps the electronic module.

7. The inspection device of claim 6, wherein the first block of the display panel includes:
a module area which overlaps the electronic module;
a peripheral area which surrounds the module area; and
a general area which surrounds the peripheral area.

8. The inspection device of claim 7, wherein the display panel includes first pixels disposed in the general area and second pixels disposed in the peripheral area, and wherein a pixel density of the second pixels is greater than a pixel density of the first pixels.

9. The inspection device of claim 8, wherein a luminance of the second pixels is higher than a luminance of the first pixels for a same grayscale level.

10. The inspection device of claim 3, further comprising:
a target luminance setting unit configured to output one of a plurality of normal target luminances corresponding to the second block and a plurality of extra target luminances corresponding to the first block as a current target luminance.

11. The inspection device of claim 10, wherein the driving voltage determination unit is configured to determine the voltage level of the driving voltage according to the current target luminance based on the luminance signal.

12. The inspection device of claim 10, wherein the driving voltage offset lookup table is configured to store a plurality of offset voltages respectively corresponding to the plurality of extra target luminances and including the offset voltage.

13. The inspection device of claim 12, wherein the target luminance setting unit is configured to output one of the plurality of extra target luminances as the current target luminance in response to the state in which the luminance signal corresponding to the first block is received.

14. The inspection device of claim 13, wherein the gamma voltage determination unit is configured to adjust the voltage level of the driving voltage based on an offset voltage corresponding to the current target luminance among the plurality of offset voltages in response to the state in which the luminance signal corresponding to the first block is received.

15. The inspection device of claim 13, wherein the offset compensation unit is configured to store a plurality of offset compensation values respectively corresponding to the plurality of extra target luminances.

16. The inspection device of claim 15, wherein the offset compensation unit is configured to output the final gamma lookup table which compensates for the error of the gamma lookup table based on an offset compensation value corresponding to the current target luminance among the plurality of offset compensation values in response to the state in which the luminance signal corresponding to the first block is received.

17. An electronic device comprising:
an electronic module;
a display panel including:
a plurality of pixels;
a plurality of data lines;
a plurality of scan lines;
a module area overlapping the electronic module;
a peripheral area surrounding the module area; and
a general area surrounding the peripheral area;
a data driving circuit configured to drive the plurality of data lines;
a scan driving circuit configured to drive the plurality of scan lines;
a driving controller configured to:
receive a control signal and an input image signal; and
provide a data signal to the data driving circuit;
a memory configured to store a final gamma lookup table and a driving voltage signal, the final gamma lookup table being provided from an inspection device; and
a voltage generator configured to generate a driving voltage corresponding to the driving voltage signal,
wherein the driving controller outputs the data signal corresponding to the input image signal by referring to the final gamma lookup table, and
wherein, for the data signal with a same grayscale, a luminance of first pixels disposed in the general area among the plurality of pixels and a luminance of second pixels disposed in the peripheral area are different from each other.

18. The electronic device of claim 17, wherein a pixel density of the second pixels disposed in the peripheral area of the display panel is lower than a pixel density of the first pixels disposed in the general area.

19. The electronic device of claim 17, wherein a bit width of the data signal corresponding to the second pixels is larger than a bit width of the data signal corresponding to the first pixels.

20. The electronic device of claim 17, wherein, for the data signal with the same grayscale, the luminance of the second pixels is higher than the luminance of the first pixels.
